(19) United States
(12) Patent Application Publication
(10) Pub. No.: US 2005/0109016 A1
(43) Pub. Date: May 26, 2005

(54) Turbine tip clearance control system

(76) Inventor: Richard Ullyott, Saint-Bruno (CA)

Correspondence Address: OGILVY RENAULT (PWC), 1981 MCGILL COLLEGE AVENUE, SUITE 1600, MONTREAL, QC, H3A 2Y3, CA

(21) Appl. No.: 10/717,624

(22) Filed: Nov. 21, 2003

(51) Int. Cl. F02C 7/12

(52) U.S. Cl. 60/282; 60/785; 415/178

(57) ABSTRACT

An apparatus and method for selectively cooling a gas turbine engine component for the purpose of controlling blade tip clearance during transient conditions, wherein cooling air is admitted intermittently according to a desired a duty cycle based on a present or anticipated transient condition.

### FIELD OF THE INVENTION

The present invention generally relates to gas turbine engines, and more particularly to clearance control between turbine rotor blade tips and a stator shroud assembly radially spaced apart therefrom.

### BACKGROUND OF THE INVENTION

It is desirable to maintain the clearance gap between turbine blade tips and the static shroud assembly as small as possible throughout the engine operation range because the gap is essentially inversely proportioned to efficiency. However, because the material of the stator components and the turbine rotor are different, and because thermal inertia has an influence on the expansion of the rotor, the stator components, the engine case, outer air seal, and support mechanism all expand at different rates. Therefore, the gap must be sized larger than would otherwise be desirable to avoid the possibility of contact at certain transient conditions. When operating the engine during a transitional period, the thermal response rates of the casing and the rotor blades are difficult to match, thereby resulting in a pinch-point. This pinch-point causes a system limitation as to the minimum achievable tip clearance without rubbing.

Conventionally, small gas turbine engines typically use a passive tip clearance control system Such as the use of full pressure compressor air as a cooling medium and as the air seals around the blade tips. The cooling air is exhausted into the turbine combustion gas path.

Larger engines have often used active tip clearance control where inter-stage compressor bleed air is used to externally cool the turbine casing, typically in an impingement manner. This inter-stage compressor bleed air can be turned off during initial operation so as to avoid the pinch-point. When the engine has thermally stabilized, the bleed air cools the turbine casing effectively contracts to minimize tip clearance. Typically, this inter-stage compressor bleed air is dumped into the nacelle and lost to the cycle after having cooled the turbine casing.

Various efforts have been made to improve turbine tip clearance control in gas turbine engines. Examples include U.S. Pat. No. 4,069,662 to Redinger Jr. et al. on Jan. 24, 1978. Nevertheless, continuous efforts to develop the technology in this field are still needed in order to achieve better performance of gas turbine engines, particularly for use with aircraft. The prior art offers complex solutions which do not maximize the efficiency of cooling air systems in the engine. Improvements are therefore desired.

### SUMMARY OF THE INVENTION

The present invention provides a system for turbine tip clearance control based on diverting inter-stage compressor bleed air through the high pressure (HP) shroud area when required.

In accordance with an embodiment of the invention, there is provided, in a gas turbine engine, a method for controlling a gap between a rotor blade tip and a turbine shroud. The method comprises determining a cooling air requirement for the shroud and controlling admission of cooling air to the turbine shroud area by adjusting a duty cycle of a modulating signal according to the previously determined cooling air requirement. In particular embodiments, the cooling air requirement is determined from the aircraft's flight condition communicated from the air data computer, and/or outputs from the fuel control unit, a high pressure turbine rotation speed, a combustor entrance temperature, and/or a combustor exit temperature determined either directly by measurement or derived from turbine temperature sensed downstream.

In accordance with another aspect of the invention, there is provided a turbine shroud cooling arrangement in a gas( turbine engine for controlling a gap between a rotor blade tip and said turbine shroud and according to a cooling air requirement of the turbine shroud. The arrangement comprises an air passage bringing relatively cool air to the turbine shroud. The arrangement also comprises a valve controlling air through the air passage. Finally, the arrangement comprises a valve control unit adjusting a duty cycle of a modulating signal controlling the valve according to the cooling air requirement.

The valve may be a simple solenoid type “on-off” valve. In a preferred embodiment, the invention applies the concept of pulse width modulation (PWM) to this simple on-off valve. The method of the invention thereby achieves partial tip clearance control for certain mission conditions. Controlling blade tip clearance by selecting the air admission based on a duty cycle (PWM) has the advantage that a simple and cheap on-off valve may be used instead of a valve that is capable of various positions between fully open and fully closed.

Other advantages and features of the present invention will be better understood with reference to a preferred embodiment described hereinafter.

### BRIEF DESCRIPTION OF THE DRAWINGS

Having thus generally described the nature of the present invention, reference will now be made to the accompanying drawings, showing by way of illustration the preferred embodiment thereof, in which:

FIG. 1 is a longitudinal cross-sectional schematic view of a gas turbine engine incorporating one embodiment of the present invention;

FIG. 2 is a longitudinal cross-sectional of a turbine shroud support configuration used in the embodiment shown in FIG. 1;

FIG. 3 is an enlarged center portion of FIG. 2, more clearly illustrating the features of the invention;

FIG. 4 is a schematic diagram of turbine tip clearance control system in accordance with an embodiment of the invention; and

FIGS. 5a and 5b are graphs showing duty cycles of a valve in light cooling and heavy cooling modes respectively.

### DETAILED DESCRIPTION OF THE INVENTION

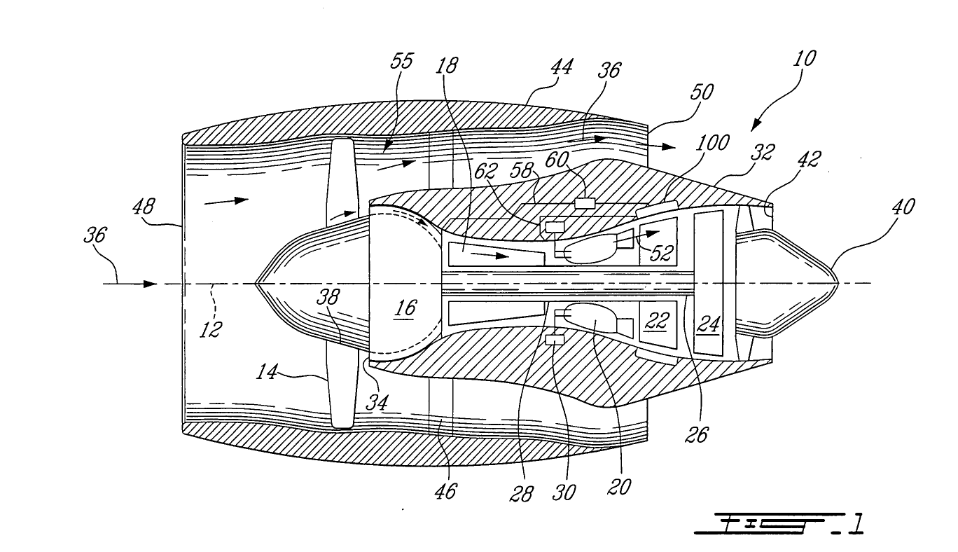

Referring to the drawings, particularly FIG. 1, an exemplary subsonic gas turbine engine 10 includes in serial flow communication a fan 14, a low pressure compressor 16, a high pressure compressor 18, a combustor 20, a high pressure turbine 22 which includes a turbine shroud support configuration 100 according to one embodiment of the present invention, and a low pressure turbine 24. The low pressure turbine 24 is operatively connected to the low pressure compressor 16 and the fan 14 by a first rotor shaft 26, and the high pressure turbine 22 is operatively connected to the high pressure compressor 18 by a second rotor shaft 28. Fuel injecting means 30 are provided for selectively injecting fuel into the combustor 20, for powering the engine 10.

An annular casing 32 surrounds the engine 10. Surrounding the casing 32 is a nacelle 44 which is spaced radially outwardly from the casing 32 to define an annular bypass duct 55. Inter-stage compressor bleed air is introduced by an air passage 58 which is schematically shown to the turbine shroud support configuration 100 for cooling same and controlling turbine tip clearance as described below. A switching valve 60 is provided for controlling the inter-stage bleed air passing through the passage 58. Full pressure compressed air is also introduced, for example by a passage which is schematically shown and indicated by numeral 62, to the turbine shroud support configuration 100.

The turbine shroud support configuration 100 according to one embodiment of the present invention is described in co-pending application Ser. No. 10/426,051 filed 28 Apr. 2003, commonly owned herewith, and the contents of which are incorporated herein by reference.

The switching valve 60 is connected in the air passage 58 and has an “on” position and preferably an “off” position. When the switching valve 60 is in the “on” position, a portion of the air flow passing through the air passage 58 is diverted into branch air passage 58a, the portion preferably 50 percent of the flow, and the other portion, preferably the other 50 percent of the flow into branch air passage 58b. When the switching valve 60 is in the “off” position, the branch air passage 58a is shut off and the entire air flow from air passage 58 is directed into branch air passage 58b. Although a complete ‘shut-off’ of passage 58a is preferred here, for reasons described below, it is not necessary and the respective flows through passages 58a and 58b can be selected by the designer as desired.

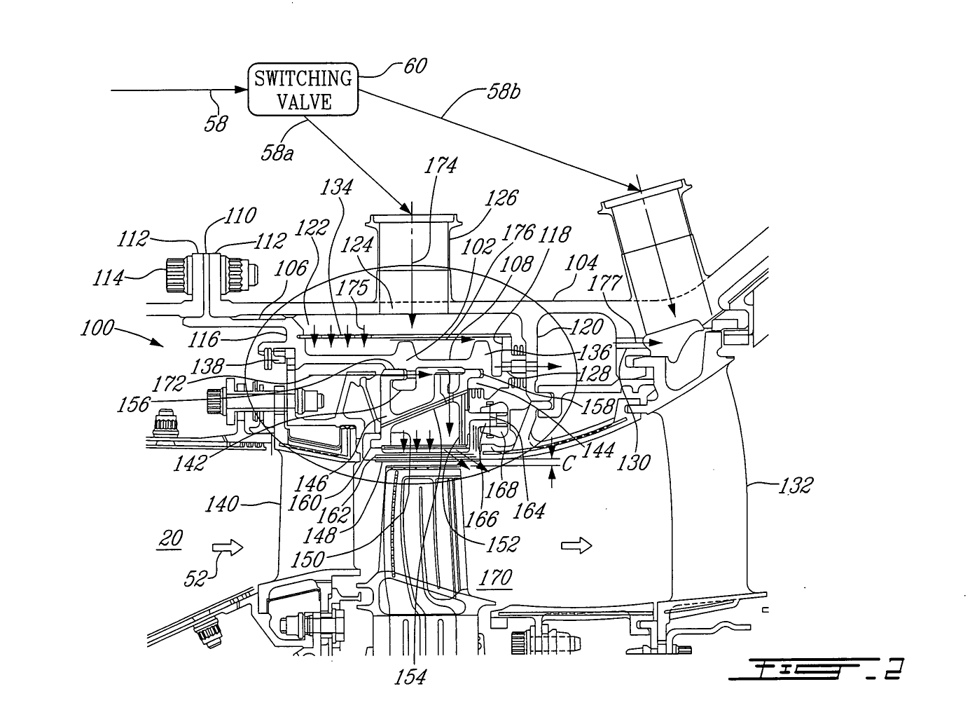

Generally, during engine transient conditions, such as startup run-up or other transient operating condition in the engine operating cycle, the switching valve 60 is in the “off” position and the inter-stage compressor bleed air from passage 58 passes through the branch air passage 58b to cool the downstream components of the turbine, such as low pressure turbine (LPT) stator and/or vanes 132. When the engine has reached steady state condition, such as cruise, the engine stabilizes thermally such that the pinch point is avoided, the switching valve 60 is activated to its “on” position so that about 50 percent (preferably) of the inter-stage compressor bleed air flow is directed from passage 58 through branch air passage 58a, to provide the cooling air flow 174 for cooling the annular shroud housing 102. Meanwhile, the remaining inter-stage compressor bleed air flow is directed through branch air passage 58b to continue cooling the downstream turbine components. The cooling air flow 174 is directed to pass through the impingement skin 134 (as represented by arrows 175 in FIGS. 2 and 3) to thereby impinge on the annular shroud housing 102 and then flow along the external surface of the annular shroud housing 102 (as represented by arrow 176 in FIGS. 2 and 3), passing fins 136 thereof to further cool the annular shroud housing 102, before being discharged through the downstream air passage 130 (as represented by arrow 177 in FIG. 2) in order to cool the downstream turbine components such as the LPT vanes and/or stator 132. The air flow 174 is not discharged into the combustion gas path 170 and therefore requires only a relatively low pressure (relative to the P3 flow) to deliver the air flow 174 for cooling the engine components. The inter-stage compressor bleed air has a relatively lower temperature and a low air pressure, and is therefore a preferable source of cooling air 174 than using P3 air, when possible. Thus, the cooling air flow 174 not only provides an additional cooling, with respect to the cooling provided by air flow 172, to the entire turbine shroud and support structure to improve cooling efficiency, but also provides more flexibility for tuning turbine tip clearance because of the relatively low temperature of the cooling air source. The re-use of the shroud cooling air flow 174 advantageously minimizes parasitic secondary air system loses of engine performance.

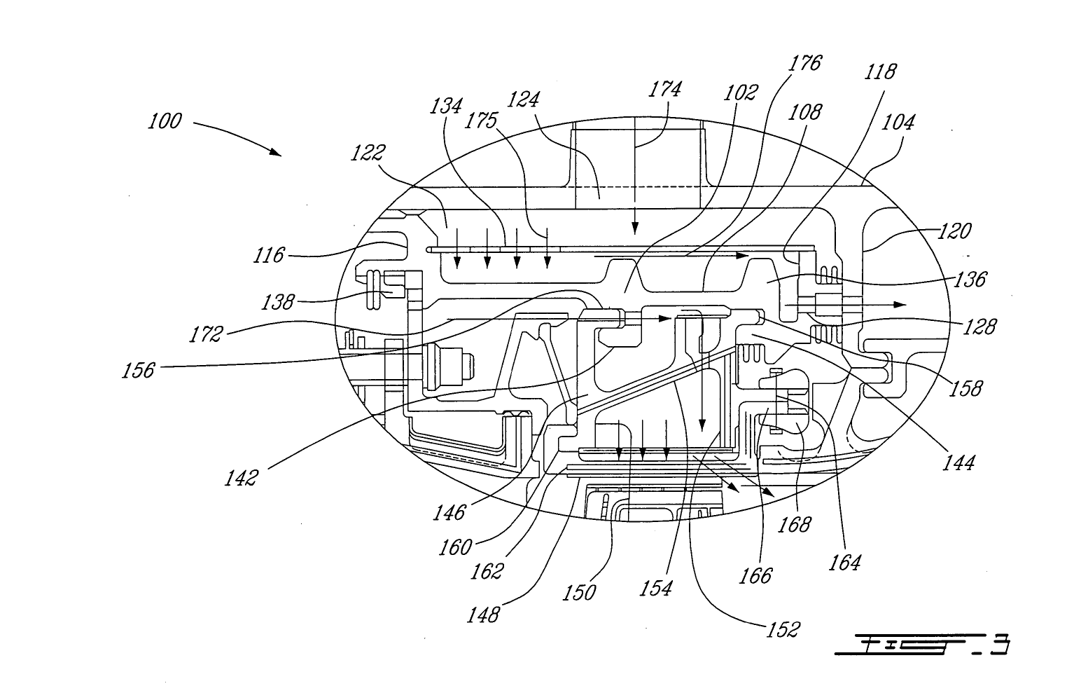

Referring to FIG. 4, valve 60 on air passage 58a brings relatively cool (preferably inter-stage P2.8 air) to a high pressure turbine shroud area 402. The other air passage 58b brings relatively cool air to the low pressure turbine area. Embodiments where air passage 58b is not present are also contemplated.

In use, valve 60 receives a control signal 406 from a valve control unit 404 which receives a signal 400 representative of an operating condition of engine 10 (e.g., a cool air requirement signal). The cooling air requirement depends mostly on the aircraft cycle conditions. The mission conditions may be one or more of the following: start, take-off, run-up, landing, normal cruise, low-level cruise, high-level cruise, reverse thrust, climb and descent. The cooling air requirement signal 400 may be derived, for example, any of the following, individually or in combination: aircraft flight condition communicated by the aircraft air data computer, pilot flight control settings such as the fuel control lever position, the fuel control unit, an engine controller such as an electric engine controller (EEC) or similar type device (not shown), a high pressure turbine 22 rotation speed (Nh), combustor 20 entrance temperature (T3), and combustor 20 exit temperature (T4). The combustor exit temperature may be directly sensed or indirectly determined from downstream turbine temperatures.

Those skilled in the art will understand that valve 60 land valve control unit 404 may combined as a single unit. In a preferred embodiment, valve 60 is a simple on-off solenoid valve.

In a preferred embodiment, control signal 406 may be a modulation signal. In a further preferred embodiment, the modulation signal is a pulse width modulation signal (PWM) which is applied to the simple on-off valve 60.

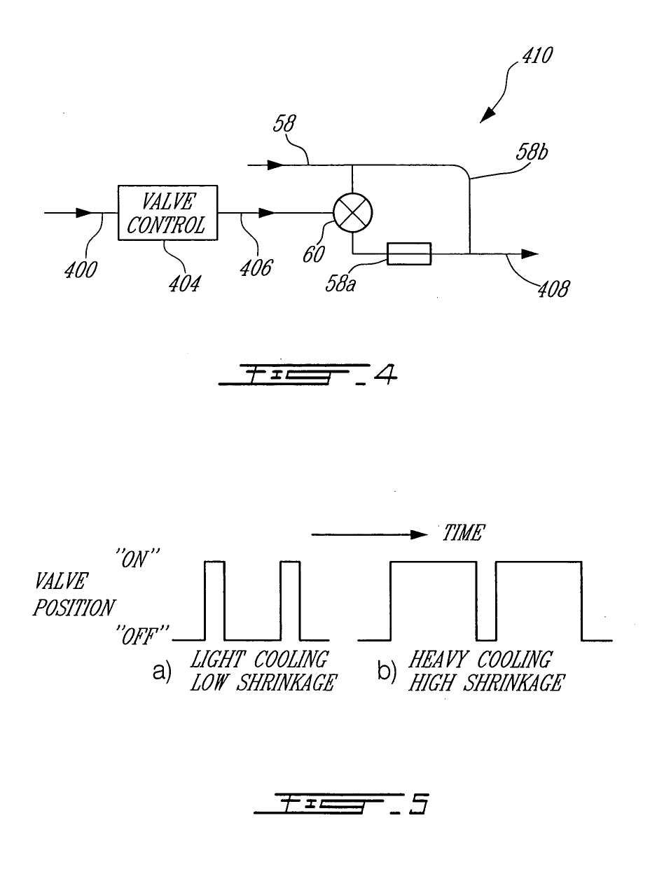

Now referring to FIG. 5, the flow of air in air passage 58a is intermittently admitted, referred to herein as “duty cycle controlled”, to the high pressure turbine (HPT) shroud area 402. By controlling the duty cycle, for example through pulse width modulation of the valve position (e.g., ON and OFF), enhanced cooling control is thereby achieved. In the example of FIG. 5a, when the duty cycle is low, say 10% (e.g., 10% ON, 90% OFF), light cooling is provided to the shroud area and low “shrinkage” of the shroud results. In the example of FIG. 5b, when the duty cycle is high, say 90%, heavy cooling is provided to the shroud area and high “shrinkage” of the shroud results. Light cooling may be achieved in a given engine configuration with a duty cycle between 0% and 30%, and heavy cooling may be achieved with a duty cycle between 70% and 100%. Other useful duty cycle values range between 5% and 15%, and 85% and 95%, for light cooling and heavy cooling respectively. It will be understood however that the duty cycle could be any desired, recognizing however that the maximum PWM modulating frequency is of course dependent on the response time of the solenoid valve 60.

Advantageously the turbine shroud area 402 thermal response is slow enough such that the valve 60 may have a reasonably slow duty cycle (a few seconds on, a few seconds off), and this does not require very rapid response rates nor require significant cyclic variations during engine performance.

The turbine tip clearance control system disclosed herein provides a cost and weight advantage when, for example, partial control is required on an infrequent basis. For example, in a critical low altitude cruise phase in a tactical military application where fuel burn is vitally important. In another example, the instant invention could be used provide partial control and help optimize casing growth during aircraft climb to yield fuel burn improvements on commercial missions. Part load efficiency of industrial or marine gas turbines may be improved where the turbine tip clearance is a factor in efficiency at reduced load of by a similar means. The cost and weight savings of the PWM controlled on-off solenoid valve embodiment of the present invention is advantageous prior art over complex, heavier and more expensive proportional valve systems.

The switching valve 60 can be any suitable valve, switch, or other means for controlling the flow of air directed to provide turbine tip clearance cooling as described above. The switching valve 60 can be controlled at any time during the engine operation, to control the turbine tip clearance during various engine operative conditions. The invention may similarly be used to control the cooling of other components besides turbine shrouds.

Passages 58 and 62 in FIG. 1 are exemplary, schematically illustrating the respective cooling air sources, and are not intended to be limited to any particular structural arrangement for obtaining the respective inter-stage compressor bleed air (i.e. P2.X) and full pressure (i.e. P.3) compressor delivered air. It will be understood that these can be achieved using a variety of other arrangements.

One skilled in the art will understand, in light of this disclosure, that switching, valve 60 may be replaced by any functional equivalent which permits the air flow through air passage 58a to be controlled, restricted or stopped, as desired by the designer. For example, a simple open/closed valve or other flow control member may be placed downstream of the branch between passages 58a and 58b. Other configurations will also be apparent to the skilled reader and thus are not intended to be outside the scope of the present disclosure.

The present invention can be applied to various types of gas turbine engines without departing from the spirit of this invention. The use of P2.X inter-stage compressor air preferred but not necessary.

Modifications and improvements to the above-described embodiment of the present invention may become apparent to those skilled in the art. The foregoing description is intended to be exemplary rather than limiting. The scope of the invention is therefore intended to be limited solely by the scope of the appended claims.

1. In a gas turbine engine, a method for controlling a gap between a rotor blade tip and a turbine shroud, said method comprising:
determining a cooling air requirement for said shroud; and
controlling admission of cooling air to said turbine shroud area by adjusting a duty cycle of a modulating signal according to said cooling air requirement.

2. The method of claim 1, wherein said determining cooling air requirement comprises using a signal representative an operating condition of said gas turbine engine.

3. The method of claim 2, wherein said signal representative of an operating condition is derived from at least one of a flight condition, a flight control setting, a fuel control unit signal, a high pressure turbine rotation speed, a combustor entrance temperature, and a combustor exit temperature.

4. The method of claim 2, wherein said operating condition is dependent on at least one of an aircraft cycle condition of said gas turbine selected from the group consisting of start, take-off, run-up, landing, normal cruise, low-level cruise, high-level cruise, low speed cruise, high speed cruise, reverse thrust, climb and descent.

5. The method of claim 1, wherein said gas turbine engine comprises a valve controlling an air passage for said cooling air and wherein said controlling admission of cooling air comprises controlling said valve.

6. The method of claim 5, wherein said valve is positionable in one of a fully open (on) position, when maximal air cooling results, and a fully closed (off) position, when no air cooling results.

7. The method of claim 5, wherein said controlling said valve comprises using pulse width modulation to control said valve.

8. The method of claim 1, wherein said modulating signal determines the position of said valve.

9. The method of claim 1, wherein said duty cycle comprises a light cooling mode and heavy cooling mode, wherein less cooling air is provided to the turbine area in said light cooling mode than in said heavy cooling mode.

10. The method of claim 9, wherein said duty cycle, in said light cooling mode, comprises values between 0% and 50% and, in said heavy cooling mode, comprises values between 50% and 100%.

11. The method of claim 1, wherein said modulating signal comprises a pulse width modulation signal.

12. A turbine section cooling arrangement in a gas turbine engine for controlling a clearance gap between a rotor blade tip and a surrounding structure according to a cooling air requirement of said turbine section, said arrangement comprising:
an air passage bringing cooling air to said turbine section;
a valve controlling air through said air passage; and
a valve control unit adjusting a duty cycle of a modulating signal controlling said valve according to said cooling air requirement.

13. The cooling arrangement of claim 12 wherein the turbine section is a turbine shroud.

14. The cooling arrangement of claim 12, wherein said valve is positionable in one of a fully open (on) position, when maximal air cooling to said turbine section results, and a fully closed (off) position, when no air cooling to said turbine shroud results.

15. The cooling arrangement of claim 12, wherein said valve control unit uses a signal representative an operating condition of said gas turbine engine for controlling said valve.

16. The cooling arrangement of claim 15, wherein said signal representative of an operating condition is derived from at least one of a flight condition, a flight control setting, a fuel control unit signal, a high pressure turbine rotation speed, a combustor entrance temperature, and a combustor exit temperature.

17. The cooling arrangement of claim 15, wherein said operating condition is dependent on at least one of an aircraft cycle condition of said gas turbine selected from the group consisting of start; take-off, run-up, landing, normal cruise, low-level cruise, high-level cruise, low speed cruise, high speed cruise, reverse thrust, climb and descent.

18. The cooling arrangement of claim 15, wherein said valve control unit uses pulse width modulation for controlling said valve.

19. The cooling arrangement of claim 12, wherein said modulating signal determines the position of said valve.

20. The cooling arrangement of claim 12, wherein said duty cycle comprises a light cooling mode and heavy cooling mode, wherein less cooling air is provided to the turbine area in said light cooling mode than in said heavy cooling mode.

21. The cooling arrangement of claim 20, wherein said duty cycle, in said light cooling mode, comprises values between 0% and 50% and, in said heavy cooling mode, comprises values between 50% and 100%.

22. The cooling arrangement of claim 12 wherein said modulating signal comprises a pulse width modulation signal.
